(19) United States
(12) Patent Application Publication
(10) Pub. No.: US 2026/0303644 A1
(43) Pub. Date: Oct. 1, 2026

(54) NEXT DEVICE PREDICTION SYSTEM AND METHOD

(71) Applicant: PLUME DESIGN, INC., Palo Alto, CA (US)

(72) Inventor: Abinash MAHAPATRA, Cupertino, CA (US)

(21) Appl. No.: 19/097,169

(22) Filed: Apr. 1, 2025

(51) Int. Cl. H04L 9/40; G06N 20/00

(52) U.S. Cl. CPC H04L 63/1433; G06N 20/00

(57) ABSTRACT

The techniques described herein relate to a method including: collecting, by a processor, network data from a household network, the network data including one or more of device inventory data, application usage data, and network usage patterns; generating, by the processor, a feature vector based on the network data; inputting, by the processor, the feature vector into a machine learning model trained to predict future device additions to the household network; receiving, by the processor, a prediction from the machine learning model, the prediction identifying a device type predicted to be added to the household network; storing, by the processor, the prediction in a database; monitoring, by the processor, the household network to detect actual device additions; comparing, by the processor, the actual device additions with the prediction to determine a prediction accuracy value; and updating, by the processor, the machine learning model based on the prediction accuracy value.

### BACKGROUND

Home networks continue to grow increasingly complex, with the average household now containing dozens of connected devices spanning multiple technology ecosystems. As homes become more technologically sophisticated, users frequently add new devices to their networks to enhance convenience, entertainment, security, and productivity. These devices include smartphones, tablets, smart speakers, security cameras, streaming devices, gaming consoles, smart appliances, and various Internet of Things (IoT) sensors and controllers.

The proliferation of connected devices has created challenges for both consumers and network providers. Users often struggle to maintain optimal network performance as new devices compete for bandwidth and coverage. Network configuration becomes increasingly complicated with each device addition, particularly when devices utilize different communication protocols or have specific connectivity requirements. Security concerns also multiply as each new device potentially introduces vulnerabilities to the home network.

Traditional network management approaches focus primarily on monitoring and optimizing existing device connections rather than anticipating future network needs. When users add new devices, they typically must manually configure network settings, troubleshoot connectivity issues, and determine appropriate security parameters. This reactive approach often results in temporary network disruptions, suboptimal device placement, inadequate security provisions, and frustration for users who expect seamless technology integration.

Network management systems have historically lacked visibility into users'future technology adoption plans, limiting their ability to prepare network infrastructure proactively. While some systems may detect when new devices connect to a network, they generally cannot anticipate these connections in advance. This limitation prevents the implementation of preparatory optimizations that could enhance the user experience when adding new devices.

Improved methods for managing evolving home networks and enhancing the device addition experience would benefit both users and network service providers.

### BRIEF DESCRIPTION OF THE FIGURES

FIG. 1 is a block diagram illustrating a system for predicting next device acquisitions according to some of the disclosed embodiments.

FIG. 2 is a flow diagram illustrating a method for collecting data and training prediction models according to some of the disclosed embodiments.

FIG. 3 is a flow diagram illustrating a method for predicting next device acquisitions and generating recommendations according to some of the disclosed embodiments.

FIG. 4 is a flow diagram illustrating a method for validating prediction accuracy and improving the prediction models according to some of the disclosed embodiments.

FIG. 5 is a flow diagram illustrating a method for executing an interactive challenge according to some of the disclosed embodiments.

FIG. 6 is a flow diagram illustrating a method for optimizing network configurations based on predicted device acquisitions according to some of the disclosed embodiments.

FIG. 7 is a flow diagram illustrating a method for assessing security implications of predicted device acquisitions according to some of the disclosed embodiments.

FIG. 8 is a flow diagram illustrating a method for applying prediction and analysis capabilities to business environments according to some of the disclosed embodiments.

FIG. 9 is a block diagram of a computing device according to some embodiments of the disclosure.

### DETAILED DESCRIPTION

Current network management systems lack the technical capability to predict future device additions to home networks before they occur. This limitation stems from an inability to correlate multi-dimensional household data—including device inventories, network usage patterns, application utilization metrics, and household composition data—into predictive insights about future connectivity needs. Without this predictive capability, network systems cannot pre-configure optimal network settings, prepare bandwidth allocation strategies, or generate device-specific security policies until after a new device has already been connected to the network. The result is a strictly reactive approach to network optimization that leads to suboptimal device performance, potential security vulnerabilities during the initial connection period, and unnecessary configuration complexity as settings must be adjusted in real-time while the device is actively communicating on the network.

The technology described herein addresses this problem through a multi-stage machine learning system that analyzes household network data to predict device additions before they occur. The system collects comprehensive network telemetry, device inventory data, temporal usage patterns, and connection metrics to construct feature vectors representing household technology environments. These feature vectors serve as inputs to specialized machine learning models that identify correlations between existing household characteristics and likely future device additions. By implementing a two-stage prediction architecture—first categorizing potential device types, then determining specific models based on ecosystem compatibility—the system achieves high prediction accuracy while maintaining computational efficiency. The predictions then drive automated network preparation processes including pre-generated device profiles, proactive bandwidth allocation parameters, custom security rule formulation, and coverage optimization calculations. This technological approach transforms network management from a reactive to a proactive paradigm, ensuring that when new devices are connected, the network environment is already technically optimized for their specific requirements, eliminating the configuration delays and performance issues associated with traditional detection-based approaches.

In some implementations, the techniques described herein relate to a method including: collecting, by a processor, network data from a household network, the network data including one or more of device inventory data, application usage data, and network usage patterns; generating, by the processor, a feature vector based on the network data; inputting, by the processor, the feature vector into a machine learning model trained to predict future device additions to the household network; receiving, by the processor, a prediction from the machine learning model, the prediction identifying a device type predicted to be added to the household network; storing, by the processor, the prediction in a database; monitoring, by the processor, the household network to detect actual device additions; comparing, by the processor, the actual device additions with the prediction to determine a prediction accuracy value; and updating, by the processor, the machine learning model based on the prediction accuracy value.

In some implementations, the techniques described herein relate to a method, wherein collecting network data from the household network includes: identifying connected devices on the household network; determining a device type, brand, and model for each identified connected device; monitoring application access patterns through the household network; and measuring bandwidth consumption and peak usage times.

In some implementations, the techniques described herein relate to a method, further including: generating, by the processor, network optimization parameters based on the prediction, the network optimization parameters including bandwidth allocation settings, coverage requirements, and device placement recommendations; creating, by the processor, a digital twin of the household network; simulating, by the processor, addition of the device type to the digital twin; and generating, by the processor, modified network settings based on simulation results.

In some implementations, the techniques described herein relate to a method, further including: generating, by the processor, a security risk assessment for the device type; querying, by the processor, a vulnerability database to identify security vulnerabilities associated with the device type; calculating, by the processor, a security risk score based on the security vulnerabilities; and generating, by the processor, security mitigation recommendations based on the security risk score.

In some implementations, the techniques described herein relate to a method, wherein the machine learning model includes: a first prediction model trained to predict a device category; and a second prediction model trained to predict a specific device type within the device category, wherein the prediction includes both the device category and the specific device type.

In some implementations, the techniques described herein relate to a method, further including: generating, by the processor, an interactive challenge for a user based on the prediction; presenting, by the processor, a sequence of questions to the user through a user interface; receiving, by the processor, user responses to the sequence of questions; comparing, by the processor, the user responses with the prediction to determine an interactive validation score; and updating, by the processor, the machine learning model based on the interactive validation score.

In some implementations, the techniques described herein relate to a method, wherein updating the machine learning model based on the prediction accuracy value includes: identifying, by the processor, prediction error patterns; updating, by the processor, a training dataset to include the actual device additions; adjusting, by the processor, feature extraction parameters based on the prediction error patterns; and retraining, by the processor, the machine learning model using the training dataset and adjusted feature extraction parameters.

In some implementations, the techniques described herein relate to a non-transitory computer-readable storage medium for tangibly storing computer program instructions capable of being executed by a processor, the computer program instructions defining steps of: collecting, by a processor, network data from a household network, the network data including one or more of device inventory data, application usage data, and network usage patterns; generating, by the processor, a feature vector based on the network data; inputting, by the processor, the feature vector into a machine learning model trained to predict future device additions to the household network; receiving, by the processor, a prediction from the machine learning model, the prediction identifying a device type predicted to be added to the household network; storing, by the processor, the prediction in a database; monitoring, by the processor, the household network to detect actual device additions; comparing, by the processor, the actual device additions with the prediction to determine a prediction accuracy value; and updating, by the processor, the machine learning model based on the prediction accuracy value.

In some implementations, the techniques described herein relate to a non-transitory computer-readable storage medium, wherein collecting network data from the household network includes: identifying connected devices on the household network; determining a device type, brand, and model for each identified connected device; monitoring application access patterns through the household network; and measuring bandwidth consumption and peak usage times.

In some implementations, the techniques described herein relate to a non-transitory computer-readable storage medium, the steps further including: generating, by the processor, network optimization parameters based on the prediction, the network optimization parameters including bandwidth allocation settings, coverage requirements, and device placement recommendations; creating, by the processor, a digital twin of the household network; simulating, by the processor, addition of the device type to the digital twin; and generating, by the processor, modified network settings based on simulation results.

In some implementations, the techniques described herein relate to a non-transitory computer-readable storage medium, the steps further including: generating, by the processor, a security risk assessment for the device type; querying, by the processor, a vulnerability database to identify security vulnerabilities associated with the device type; calculating, by the processor, a security risk score based on the security vulnerabilities; and generating, by the processor, security mitigation recommendations based on the security risk score.

In some implementations, the techniques described herein relate to a non-transitory computer-readable storage medium, wherein the machine learning model includes: a first prediction model trained to predict a device category; and a second prediction model trained to predict a specific device type within the device category, wherein the prediction includes both the device category and the specific device type.

In some implementations, the techniques described herein relate to a non-transitory computer-readable storage medium, the steps further including: generating, by the processor, an interactive challenge for a user based on the prediction; presenting, by the processor, a sequence of questions to the user through a user interface; receiving, by the processor, user responses to the sequence of questions; comparing, by the processor, the user responses with the prediction to determine an interactive validation score; and updating, by the processor, the machine learning model based on the interactive validation score.

In some implementations, the techniques described herein relate to a non-transitory computer-readable storage medium, wherein updating the machine learning model based on the prediction accuracy value includes: identifying, by the processor, prediction error patterns; updating, by the processor, a training dataset to include the actual device additions; adjusting, by the processor, feature extraction parameters based on the prediction error patterns; and retraining, by the processor, the machine learning model using the training dataset and adjusted feature extraction parameters.

In some implementations, the techniques described herein relate to a device including: a processor; and a storage medium for tangibly storing thereon program logic for execution by the processor, the program logic including steps for: collecting, by the processor, network data from a household network, the network data including one or more of device inventory data, application usage data, and network usage patterns; generating, by the processor, a feature vector based on the network data; inputting, by the processor, the feature vector into a machine learning model trained to predict future device additions to the household network; receiving, by the processor, a prediction from the machine learning model, the prediction identifying a device type predicted to be added to the household network; storing, by the processor, the prediction in a database; monitoring, by the processor, the household network to detect actual device additions; comparing, by the processor, the actual device additions with the prediction to determine a prediction accuracy value; and updating, by the processor, the machine learning model based on the prediction accuracy value.

In some implementations, the techniques described herein relate to a device, wherein collecting network data from the household network includes: identifying connected devices on the household network; determining a device type, brand, and model for each identified connected device; monitoring application access patterns through the household network; and measuring bandwidth consumption and peak usage times.

In some implementations, the techniques described herein relate to a device, the steps further including: generating, by the processor, network optimization parameters based on the prediction, the network optimization parameters including bandwidth allocation settings, coverage requirements, and device placement recommendations; creating, by the processor, a digital twin of the household network; simulating, by the processor, addition of the device type to the digital twin; and generating, by the processor, modified network settings based on simulation results.

In some implementations, the techniques described herein relate to a device, the steps further including: generating, by the processor, a security risk assessment for the device type; querying, by the processor, a vulnerability database to identify security vulnerabilities associated with the device type; calculating, by the processor, a security risk score based on the security vulnerabilities; and generating, by the processor, security mitigation recommendations based on the security risk score.

In some implementations, the techniques described herein relate to a device, the steps further including: generating, by the processor, an interactive challenge for a user based on the prediction; presenting, by the processor, a sequence of questions to the user through a user interface; receiving, by the processor, user responses to the sequence of questions; comparing, by the processor, the user responses with the prediction to determine an interactive validation score; and updating, by the processor, the machine learning model based on the interactive validation score.

In some implementations, the techniques described herein relate to a device, wherein updating the machine learning model based on the prediction accuracy value includes: identifying, by the processor, prediction error patterns; updating, by the processor, a training dataset to include the actual device additions; adjusting, by the processor, feature extraction parameters based on the prediction error patterns; and retraining, by the processor, the machine learning model using the training dataset and adjusted feature extraction parameters.

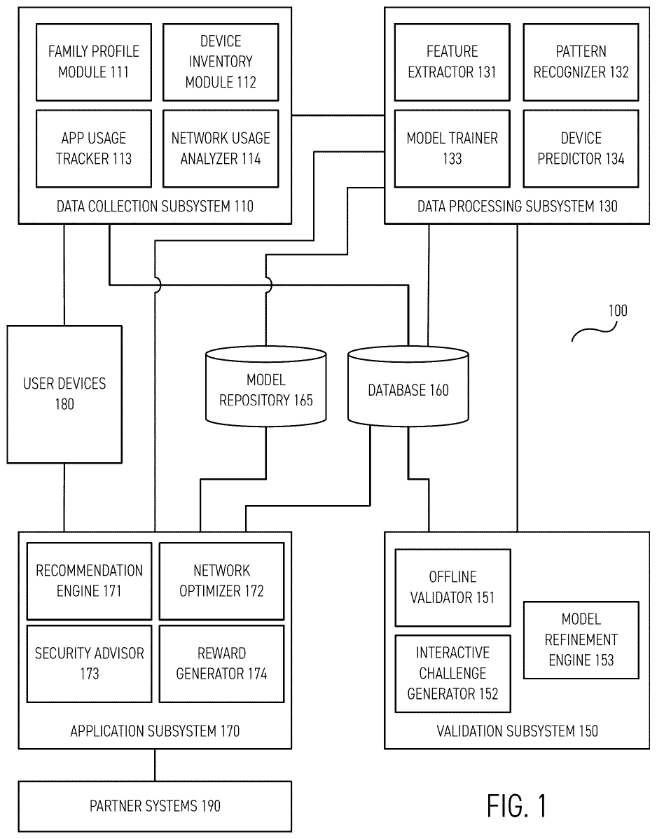

FIG. 1 is a block diagram illustrating a system for predicting next device acquisitions according to some of the disclosed embodiments.

In the illustrated embodiment, a system 100 includes a data collection subsystem 110, a data processing subsystem 130, a validation subsystem 150, and an application subsystem 170. These subsystems interact with each other and with external components including a database 160, a model repository 165, user devices 180, and partner systems 190. As illustrated, the system includes various modules distributed across the subsystems to collect, process, and utilize data for device purchase predictions.

In some implementations, the data collection subsystem 110 is communicatively coupled to user devices 180 through a bidirectional connection, allowing it to gather information about users, their households, and their digital behavior patterns. The data collection subsystem 110 includes a family profile module 111, a device inventory module 112, an app usage tracker 113, and a network usage analyzer 114. In some implementations, these modules collectively gather comprehensive data about household composition, device ownership, app usage patterns, and network activity.

The family profile module 111 collects and maintains demographic information about household members, including the number of adults, teenagers, and children in the household. This profile data establishes the household composition, which serves as a significant factor in predicting future device acquisitions based on life stage patterns.

In some implementations, the device inventory module 112 identifies and catalogs all connected devices within a household's network. In some implementations, this module can detect devices across different ecosystems, including iOS® devices, Android® devices, laptops, and various Internet of Things (IoT) devices. As will be discussed, the comprehensive inventory of current devices provides context for predicting which new devices a household might acquire next.

In some implementations, the app usage tracker 113 monitors and analyzes the applications and services accessed by users through their network. This module can identify patterns such as frequent visits to e-commerce sites, streaming services, or productivity applications, providing insights into user interests and potential future needs.

In some implementations, the network usage analyzer 114 examines network traffic patterns, including bandwidth consumption, connection times, and usage frequency. This analyzer can determine work-from-home patterns based on virtual private network (VPN) connections and can profile user activities based on their network usage characteristics.

In some implementations, data collected by the data collection subsystem 110 is transmitted to both the database 160 and the data processing subsystem 130. In some implementations, the database 160 provides persistent storage for the collected data, enabling historical analysis and trend identification.

In some implementations, the data processing subsystem 130 transforms raw collected data into actionable insights and predictions. This subsystem comprises a feature extractor 131, a pattern recognizer 132, a model trainer 133, and a device predictor 134. The data processing subsystem 130 has bidirectional communication with the database 160 and the model repository 165, allowing it to both read from and write to these storage components.

In some implementations, the feature extractor 131 processes raw data into structured features suitable for machine learning algorithms. In some implementations, this module identifies relevant variables from the collected data and transforms them into normalized representations that can be used for pattern analysis.

In some implementations, the pattern recognizer 132 identifies correlations and temporal sequences in the extracted features. In some implementations, this component recognizes patterns such as device purchase sequences that follow life events (e.g., moving to a new home, having a child, or children reaching certain age milestones). In some implementations, the pattern recognizer 132 can detect recurring patterns across different households with similar characteristics, enabling prediction of likely future purchases.

In some implementations, the model trainer 133 utilizes the extracted features and identified patterns to develop and refine machine learning models for predicting device purchases. In some implementations, the model trainer 133 can develop multiple models including clustering models and regression models that analyze different aspects of household behavior. In some implementations, the trained models are stored in the model repository 165 for use by the device predictor 134.

In some implementations, the device predictor 134 applies the trained models to current household data to generate specific predictions about future device purchases. In some implementations, the device predictor 134 can identify both the category of devices likely to be purchased (e.g., security devices, tablets, gaming consoles) and the specific brands or models based on existing ecosystem preferences and other factors.

In some implementations, the validation subsystem 150 evaluates and improves prediction accuracy through both automated analysis and user interaction. In some implementations, this subsystem includes an offline validator 151, an interactive challenge generator 152, and a model refinement engine 153. In some implementations, the validation subsystem 150 communicates with the data processing subsystem 130, database 160, and model repository 165 to access predictions, actual outcomes, and model parameters.

In some implementations, the offline validator 151 compares predicted device acquisitions with actual device additions detected by the system. In some implementations, this module calculates accuracy metrics and identifies patterns in prediction errors to guide model improvements. In some implementations, the offline validator 151 continuously monitors the network for new device additions and compares these events with prior predictions.

In some implementations, the interactive challenge generator 152 creates and manages the gamified challenge that directly engages users in validating predictions. In some implementations, this module generates personalized questions based on prediction data and presents them to users through their applications. In some implementations, the interactive challenge generator 152 structures the user interaction to both validate existing predictions and gather additional information that can improve future predictions.

In some implementations, the model refinement engine 153 utilizes feedback from both offline validation and interactive challenges to improve prediction models. In some implementations, this module identifies areas where models can be improved and coordinates with the model trainer 133 to update the models accordingly. In some implementations, the model refinement engine 153 ensures that prediction accuracy improves over time as more validation data becomes available.

In some implementations, the application subsystem 170 leverages prediction data to deliver value to users and partners. In some implementations, this subsystem includes a recommendation engine 171, a network optimizer 172, a security advisor 173, and a reward generator 174. In some implementations, the application subsystem 170 communicates with user devices 180 and partner systems 190 to deliver recommendations and receive user feedback.

In some implementations, the recommendation engine 171 generates personalized device recommendations based on prediction data. In some implementations, this module can suggest specific products that align with the household's predicted needs and existing ecosystem. In some implementations, the recommendation engine 171 considers factors such as compatibility with existing devices, user preferences, and partnership opportunities.

In some implementations, the network optimizer 172 analyzes predicted device additions to prepare the network for optimal performance. In some implementations, this module can recommend bandwidth upgrades, coverage improvements, or device placement strategies to accommodate the anticipated new devices. In some implementations, the network optimizer 172 can also pre-configure network settings for seamless integration of new devices.

In some implementations, the security advisor 173 evaluates security implications of predicted device purchases. In some implementations, this module can identify potential vulnerabilities in predicted devices and recommend safer alternatives or security measures to protect the household network. In some implementations, the security advisor 173 ensures that device recommendations consider not only functionality but also security implications.

In some implementations, the reward generator 174 creates and manages incentives for user participation in the prediction validation process. In some implementations, this module designs rewards that encourage users to engage with the gamified challenge and provide accurate feedback about their purchase intentions. In some implementations, the reward generator 174 can coordinate with partner systems 190 to offer discounts or other incentives for predicted purchases.

In some implementations, the system 100 maintains bidirectional communication with user devices 180 and partner systems 190 through the data collection subsystem 110 and application subsystem 170. In some implementations, this communication enables continuous data collection, prediction delivery, and feedback incorporation to improve prediction accuracy over time.

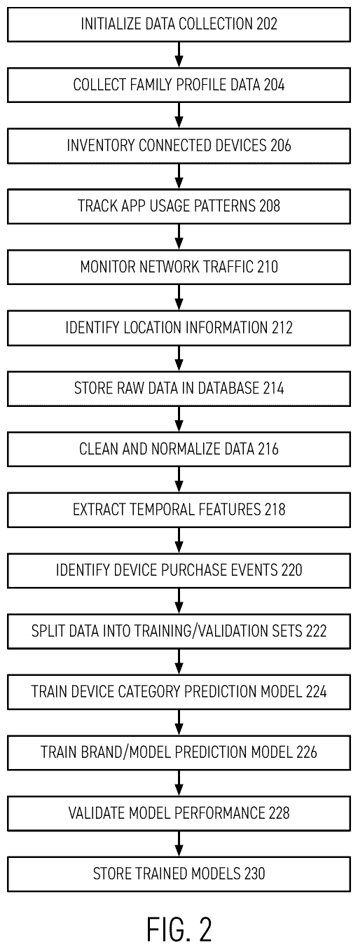

FIG. 2 is a flow diagram illustrating a method for collecting data and training prediction models according to some of the disclosed embodiments.

In step 202, the method includes initializing data collection. In some implementations, the method may be triggered based on various conditions, such as a scheduled training interval, the availability of new data, or a manual request to update prediction models. In this step, the method establishes connections to relevant data sources and prepares to gather information about households, their devices, and usage patterns. This initialization may involve configuring data collection parameters, establishing connection pools to the database, and setting up data processing pipelines. In some implementations, the method may perform a check to verify that all required data collection modules are operational before proceeding with the active collection process.

In step 204, the method includes collecting family profile data. In some implementations, the method gathers demographic information about household members to establish the composition of each household. This information may include the number of adults, teenagers, and children in the household, their approximate ages, and other relevant demographic indicators. In some implementations, this information may be explicitly provided by users during the setup process or may be inferred based on observed usage patterns. The family profile data serves as a foundation for identifying life stage patterns that correlate with specific device purchases.

In step 206, the method includes inventorying connected devices. In some implementations, the method scans the home network to identify and catalog all connected devices. This inventory process captures detailed information about each device, including device type, brand, model, operating system, and connection patterns. In some implementations, the device inventory module may use MAC address lookup, DHCP information, network fingerprinting techniques, and deep packet inspection to accurately identify devices. The device inventory provides critical context about the household's current technology ecosystem, which strongly influences future device purchases. For example, a household predominantly using Apple® products is more likely to continue purchasing within the Apple® ecosystem.

In step 208, the method includes tracking app usage patterns. In some implementations, the method monitors the applications and services accessed by household members through their network connection. This tracking provides insights into user interests, hobbies, work patterns, and entertainment preferences. In some implementations, the method may analyze DNS queries, network traffic patterns, and connection logs to identify frequently accessed applications and services. In some implementations, the method may categorize apps into groups such as productivity, entertainment, education, fitness, and social media to build a comprehensive profile of household interests and activities.

In step 210, the method includes monitoring network traffic. In some implementations, the method analyzes network usage patterns, including bandwidth consumption, connection times, and traffic distribution across devices. This monitoring can reveal work-from-home patterns, streaming habits, gaming activities, and other behavioral indicators. In some implementations, the method may identify VPN connections to determine work-from-home status, recognize high-bandwidth usage patterns associated with video streaming or online gaming, and detect IoT device communication patterns. These network usage patterns provide useful behavioral context for predicting future device needs.

In step 212, the method includes identifying location information. In some implementations, the method determines the geographical location of the household using IP-based geolocation or other available location indicators. This location data provides regional context that can influence device purchase predictions. In some implementations, the method may determine the household's region, urban/suburban/rural classification, and proximity to technology retailers. Location information is useful for identifying regional trends in device adoption and aligning predictions with local market availability.

In step 214, the method includes storing raw data in the database. In some implementations, the method saves all collected data to a persistent storage system for future processing and analysis. This storage step ensures that historical data is preserved for identifying long-term patterns and trends. In some implementations, the method may employ data partitioning strategies based on household ID, time periods, or data types to optimize storage and retrieval performance. The database may implement data retention policies that balance the need for historical analysis with privacy considerations and storage constraints.

In step 216, the method includes cleaning and normalizing data. In some implementations, the method processes the raw data to remove anomalies, handle missing values, and standardize formats for consistent analysis. This preprocessing step is useful for ensuring data quality before feature extraction. In some implementations, the method may apply techniques such as outlier detection, imputation of missing values, and normalization of numerical features to prepare the data for machine learning algorithms. Data cleaning may also involve deduplication, timestamp alignment, and resolution of conflicting information from different data sources.

In step 218, the method includes extracting temporal features. In some implementations, the method identifies time-based patterns and sequences in the data, such as device adoption timelines, usage frequency changes, and seasonal variations. These temporal features help capture the progression of household technology adoption over time. In some implementations, the method may generate features such as time since last device purchase, device replacement cycles, seasonal usage patterns, and sequential adoption behaviors. Temporal features are useful for capturing the timing aspects of device purchases, which often follow predictable life stage transitions.

In step 220, the method includes identifying device purchase events. In some implementations, the method detects and labels instances where new devices were added to household networks, creating a labeled dataset for supervised learning. These purchase events serve as the target variable for prediction models. In some implementations, the method may identify purchase events by comparing device inventories across time periods, detecting the appearance of new devices, and confirming persistent connections to distinguish permanent additions from temporary visitor devices. The method may also enrich purchase event data with contextual information about preceding activities or life events that might have triggered the purchase.

In step 222, the method includes splitting data into training and validation sets. In some implementations, the method divides the processed data into separate datasets for training and evaluating the prediction models. This split ensures that model performance can be assessed on unseen data. In some implementations, the method may employ stratified sampling techniques to maintain the distribution of different household types and purchase patterns across both training and validation sets. The method may also implement time-based splitting to ensure that models are validated on more recent data than they were trained on, simulating real-world prediction scenarios.

In step 224, the method includes training a device category prediction model. In some implementations, the method develops a machine learning model that predicts the general category of devices that a household is likely to purchase next (e.g., security devices, tablets, gaming consoles). This category-level prediction provides the first stage of the recommendation pipeline. In some implementations, the method may employ clustering algorithms to group similar households based on their profiles and device ownership patterns, then use supervised learning techniques such as random forests or gradient boosting to predict the probability of purchasing devices in each category. The category prediction model may incorporate features from all data collection modules to identify the complex relationships between household characteristics and device category preferences.

In step 226, the method includes training a brand/model prediction model. In some implementations, the system develops a more specific machine learning model that predicts the particular brand and model a household is likely to purchase within a predicted device category. This refined prediction enables highly targeted recommendations. In some implementations, the method may train separate brand/model prediction models for each device category, specializing in the unique factors that influence brand choice within that category. These models may analyze the household's existing ecosystem composition to predict ecosystem consistency, such as Apple® users being more likely to purchase additional Apple® devices.

In step 228, the method includes validating model performance. In some implementations, the method evaluates the trained models against the validation dataset to assess prediction accuracy, precision, recall, and other performance metrics. This validation step ensures that the models meet quality thresholds before deployment. In some implementations, the method may calculate category-specific performance metrics, confusion matrices, and ROC curves to comprehensively evaluate prediction quality. The validation process may also involve sensitivity analysis to identify the most influential features and potential biases in the models.

In step 230, the method includes storing trained models. In some implementations, the method saves the validated prediction models to the model repository for future use by the application subsystem. These stored models become available for generating predictions and recommendations for households. In some implementations, the method may store model metadata along with the models themselves, including training and validation performance metrics, feature importance rankings, and version information to support model management and governance processes. The model repository may maintain multiple versions of models to enable A/B testing and gradual rollout of model improvements.

After step 230, At this point, updated prediction models are available for use in the next purchase prediction and recommendation process. The method may transition to a monitoring phase where model performance is continuously observed in production, or it may trigger related processes such as model deployment or notification of updates to relevant system components.

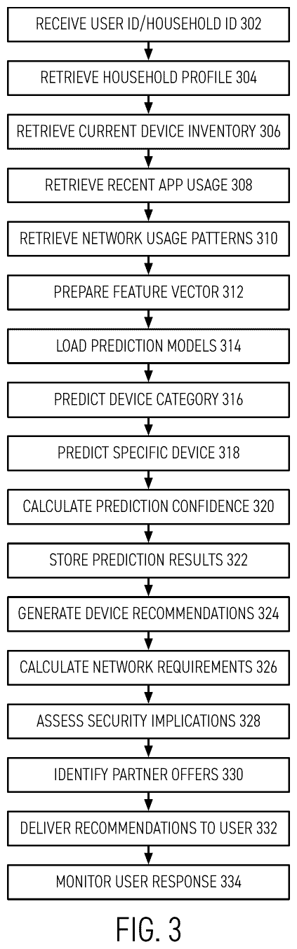

FIG. 3 is a flow diagram illustrating a method for predicting next device acquisitions and generating recommendations according to some of the disclosed embodiments.

In step 302, the method includes receiving a user ID or household ID. The method identifies the specific household for which purchase predictions will be generated. This identifier serves as the primary key for retrieving all associated household data. In some implementations, the user ID may correspond to the primary account holder, while the household ID may represent the physical location where the method is installed. The method may support multiple user IDs associated with a single household ID to accommodate family members with separate application accounts. In some implementations, the method may be triggered by various events, such as a scheduled prediction cycle, a user accessing the application, or significant changes in the household's device inventory or usage patterns.

In step 304, the method includes retrieving the household profile. In some implementations, the method loads demographic information about the household members, including the number of adults, teenagers, and children, their approximate ages, and other relevant profile data. In some implementations, this profile information may be stored in a structured format that facilitates feature extraction for the prediction models. The household profile provides critical context about the household's life stage, which strongly influences device purchase patterns. For example, households with young children may follow different device acquisition patterns than households with teenagers or households consisting only of adults.

In step 306, the method includes retrieving the current device inventory. In some implementations, the method accesses the catalog of all devices currently connected to the household network, including device types, brands, models, operating systems, and connection histories. In some implementations, the device inventory may be structured as a time-series database that tracks when devices were first detected, how frequently they connect, and their typical usage patterns. This comprehensive device inventory establishes the household's current technology ecosystem, which is a strong predictor of future acquisitions due to ecosystem loyalty and compatibility considerations.

In step 308, the method includes retrieving recent app usage data. In some implementations, the method loads information about applications and services accessed by household members, including categories, frequency, and usage duration. In some implementations, the app usage data may include website visits categorized by type (e.g., e-commerce, streaming services, productivity tools) and specific application usage detected through network traffic analysis. Recent app usage provides useful signals about user interests, emerging needs, and potential purchase intentions. For example, increased visits to baby-related websites might indicate an upcoming addition to the family, which often triggers specific device purchases.

In step 310, the method includes retrieving network usage patterns. In some implementations, the method accesses data about bandwidth consumption, peak usage times, connection frequency, and other network activity metrics. In some implementations, the network usage patterns may be aggregated into time-based summaries (hourly, daily, weekly) and device-specific profiles to identify behavioral patterns. These network patterns help establish user routines and can indicate changing needs that might drive new device purchases. For example, increasing video streaming bandwidth might precede the purchase of a smart TV or streaming device.

In step 312, the method includes preparing a feature vector. In some implementations, the method transforms and combines the retrieved data into a structured format suitable for input to the prediction models. This feature engineering step ensures that all relevant signals are properly represented for the prediction task. In some implementations, the feature vector may include hundreds of derived features such as device ecosystem composition percentages, recency-frequency-monetary (RFM) metrics for app usage, temporal patterns of network activity, and household life stage indicators. The feature preparation may also involve normalizing numerical values, encoding categorical variables, and applying dimensionality reduction techniques to enhance model performance.

In step 314, the method includes loading prediction models. In some implementations, the method retrieves the trained machine learning models from the model repository. These models have been previously trained and validated through the process described in FIG. 2. In some implementations, the method may load multiple models, including a device category prediction model and multiple brand/model prediction models specific to each device category. The method may also implement model selection logic to choose the most appropriate model version based on the household characteristics or to perform ensemble predictions combining outputs from multiple models.

In step 316, the method includes predicting the device category. In some implementations, the method applies the household feature vector to the category prediction model to determine which types of devices the household is most likely to purchase next. This category-level prediction narrows the scope for more specific predictions. In some implementations, the category prediction model may output probability scores for multiple device categories, allowing the system to consider several possible purchase paths. The model may predict categories such as security devices, smart speakers, tablets, gaming consoles, or fitness equipment based on the household's current context and identified patterns from similar households.

In step 318, the method includes predicting the specific device. Based on the predicted category, the method may apply specialized brand/model prediction models to identify the specific devices the household is most likely to purchase. In some implementations, this step may involve applying a hierarchical prediction approach where the system first predicts the manufacturer (e.g., Apple®, Samsung®, Google®) based on ecosystem affinity, then predicts the specific product line and model. The specific device prediction leverages the household's existing ecosystem preferences, compatibility requirements, and usage patterns to identify the most likely acquisitions within the predicted categories.

In step 320, the method includes calculating prediction confidence. In some implementations, the method determines the reliability of each prediction by analyzing model confidence scores, historical prediction accuracy for similar households, and the stability of input signals. This confidence assessment helps prioritize recommendations and tune the user experience. In some implementations, the system may calculate separate confidence scores for the category and specific device predictions, combining them into an overall confidence metric. The confidence calculation may also consider the recency and consistency of the data used for prediction, assigning lower confidence to predictions based on outdated or highly variable signals.

In step 322, the method includes storing prediction results. In some implementations, the method saves the generated predictions, confidence scores, and supporting data to the database for future reference, analysis, and validation. This persistent storage enables continuous improvement of the prediction system. In some implementations, the stored prediction results may include timestamps, the feature vector used for prediction, model version information, and detailed confidence metrics to support comprehensive analysis when actual purchase events occur. The stored predictions serve as the foundation for generating recommendations and for offline validation of prediction accuracy.

In step 324, the method includes generating device recommendations. Based on the prediction results, the method creates personalized device recommendations for the household. These recommendations transform raw predictions into actionable insights presented to users. In some implementations, the recommendation engine may filter and prioritize predictions based on confidence scores, seasonal relevance, and potential value to the household. The recommendations may include explanatory context to help users understand why these devices might be relevant to their needs, such as “Based on your Apple® ecosystem and your child starting school soon, an Apple® Watch® might be a good addition for location tracking and communication.”

In step 326, the method includes calculating network requirements. In some implementations, the method analyzes the network implications of the predicted device acquisitions to prepare the household network for optimal performance. In some implementations, this analysis may include estimating additional bandwidth needs, identifying potential coverage issues, and determining optimal device placement locations based on the household's existing network topology and the connectivity requirements of the predicted devices. The network requirements calculation helps ensure that recommended devices will function properly if purchased, enhancing the user experience and reducing potential frustration from network-related issues.

In step 328, the method includes assessing security implications. In some implementations, the method evaluates potential security concerns associated with the predicted device acquisitions and generates appropriate security recommendations. In some implementations, this assessment may involve checking vulnerability databases for known issues with predicted devices, analyzing the security capabilities of the devices, and identifying potential protection measures such as network isolation, custom firewall rules, or security monitoring settings. The security assessment ensures that device recommendations consider not only functionality but also the household's overall network security posture.

In step 330, the method includes identifying partner offers. In some implementations, the method matches predicted acquisitions with relevant partner promotions or special offers to enhance the value proposition for users. In some implementations, the method may maintain a database of partner relationships and available promotions, selecting those that align with the predicted devices and the household's preferences. These partner offers may include discounts, extended warranties, bundled services, or exclusive features that provide additional incentives for users to engage with the recommendations.

In step 332, the method includes delivering recommendations to the user. In some implementations, the method presents the personalized device recommendations, network insights, security advisories, and partner offers through the user interface. In some implementations, this delivery may occur through multiple channels such as email notifications or contextual alerts based on user activity. The presentation may be tailored to the household's communication preferences and interaction history, optimizing for engagement without being intrusive.

In step 334, the method includes monitoring user response. In some implementations, the method tracks how users interact with the delivered recommendations, including views, clicks, dismissals, and conversions. This response monitoring provides critical feedback for both immediate personalization adjustments and long-term model improvement. In some implementations, the method may implement a structured feedback collection mechanism that captures explicit responses (such as ratings or comments) as well as implicit signals derived from user behavior after receiving recommendations.

After step 334, the method ends. The gathered response data becomes input for future prediction cycles and model training, creating a continuous improvement loop. In some implementations, the system may schedule the next prediction cycle based on factors such as response activity, significant changes in household data, or regular time intervals to ensure recommendations remain relevant and timely.

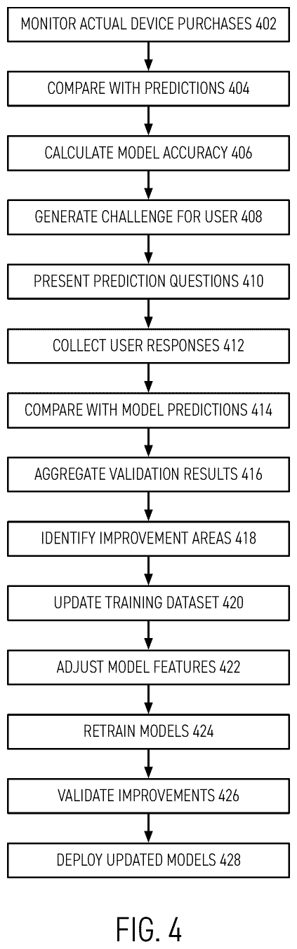

FIG. 4 is a flow diagram illustrating a method for validating prediction accuracy and improving the prediction models according to some of the disclosed embodiments.

As illustrated, the method includes two parallel validation paths that converge to provide comprehensive assessment of model performance: an offline validation path (step 402 through step 406) and an interactive validation path (step 408 through step 414). The process may run on a scheduled basis (e.g., weekly or monthly) or may be triggered by specific events such as the accumulation of a threshold number of new device acquisitions or user feedback instances.

In step 402, the method includes monitoring actual device purchases. In some implementations, the method continuously tracks new devices appearing on household networks and identifies confirmed purchase events. In some implementations, the method regularly scans connected networks to detect new devices, applying a persistence threshold to distinguish permanent additions from temporary visitor devices. In some implementations, the method may use device fingerprinting techniques to identify the specific make and model of each new device. This monitoring creates a ground truth dataset of actual purchase decisions that can be compared against previous predictions.

In step 404, the method includes comparing actual acquisitions with predictions. In some implementations, the method matches detected purchase events with previously generated predictions for the corresponding households. In some implementations, this comparison process may use fuzzy matching algorithms to account for variations in device identification between prediction and detection. For example, a prediction for an “Apple iPad” might match with a detected “iPad Pro 12.9-inch” as a correct category and brand prediction. The comparison may consider multiple prediction timeframes, such as short-term (1-30 days), medium-term (1-3 months), and long-term (3-12 months) predictions, with different accuracy expectations for each timeframe.

In step 406, the method includes calculating model accuracy metrics. In some implementations, the method evaluates prediction performance using multiple statistical measures to provide a comprehensive assessment. In some implementations, these metrics may include precision (percentage of predicted acquisitions that actually occurred), recall (percentage of actual acquisitions that were correctly predicted), F1 score (harmonic mean of precision and recall), and area under the ROC curve (AUC) for probabilistic predictions. The method may calculate separate metrics for category-level and specific device-level predictions, as well as segment-specific metrics (e.g., accuracy for households with children versus without children) to identify differential performance across user segments.

In parallel with the offline validation path, the interactive validation path begins at step 408, where the method includes generating challenges for users.

In some implementations, the method creates personalized challenges based on model predictions to engage users in validating predictions directly. In some implementations, these challenges may be strategically timed based on user engagement patterns and prediction confidence levels. The system may optimize challenge frequency to maximize user participation without creating fatigue. Challenge generation may incorporate elements of gamification to enhance user engagement, such as streak counting, achievement badges, or point systems.

In step 410, the method includes presenting prediction questions to users. In some implementations, the method formats prediction-based questions in an engaging and easy-to-answer format through the user interface. In some implementations, these questions may follow a structured sequence designed to narrow down the prediction space efficiently. For example, the method might first ask about the general category (“Are you considering purchasing a new security device?”) before asking about specific brands or models. The questions may be formulated to appear conversational and personalized based on the household's profile and history, rather than as generic surveys.

In step 412, the method includes collecting user responses. In some implementations, the method captures and stores user feedback to the prediction questions, including both direct answers and interaction patterns. In some implementations, the response collection may capture not only the explicit yes/no answers but also response time, answer changes, and interaction patterns that might indicate uncertainty or interest. In some implementations, the method may implement adaptive questioning, where follow-up questions are dynamically selected based on previous responses to gather the most useful validation information efficiently.

In step 414, the method includes comparing user responses with model predictions. In some implementations, the method evaluates how well the original predictions align with the stated intentions of users. In some implementations, this comparison may weight user responses based on confidence indicators and historical accuracy of self-reported intentions versus actual purchases. In some implementations, the method may track the correlation between stated purchase intentions and subsequent actual acquisitions to calibrate how much weight to assign to interactive validation results versus offline validation results.

In step 416, the method includes aggregating validation results from both offline and interactive paths. In some implementations, the method combines the insights from actual purchase validation and user feedback to create a comprehensive assessment of model performance. In some implementations, the aggregation process may apply different weights to offline and interactive validation results based on their observed reliability and coverage. The aggregated results may be segmented by prediction timeframe, device category, user demographic, and confidence level to identify specific patterns of prediction success and failure.

In step 418, the method includes identifying improvement areas. Based on the aggregated validation results, in some implementations, the method pinpoints specific aspects of the prediction models that require refinement. In some implementations, this analysis may use techniques such as error pattern recognition, feature importance analysis, and confusion matrix examination to identify the root causes of prediction errors. The improvement identification process may prioritize issues based on their impact on overall prediction accuracy and their relevance to high-value user segments or device categories.

In step 420, the method includes updating the training dataset. In some implementations, the method incorporates newly validated data into the training corpus to enable model retraining with more recent and accurate information. In some implementations, this update process may involve both adding new data points and potentially removing or reweighting older data that may no longer reflect current market trends or user behaviors. In some implementations, the method may implement data enrichment processes to augment the raw validation data with additional contextual information before adding it to the training dataset.

In step 422, the method includes adjusting model features. Based on validation insights, in some implementations, the method modifies the feature engineering process to better capture relevant patterns. In some implementations, this adjustment may involve creating new derived features, eliminating features with low predictive value, or transforming existing features to better represent the underlying relationships. The feature adjustment process may be partially automated through techniques such as feature importance analysis, correlation studies, and automated feature generation with manual oversight.

In step 424, the method includes retraining the prediction models. In some implementations, the method develops new versions of the models using the updated training dataset and adjusted feature set. In some implementations, the retraining process may explore multiple model architectures and hyperparameter settings to identify the optimal configuration based on validation metrics. In some implementations, the method may implement techniques such as cross-validation, regularization, and ensemble methods to enhance model robustness and generalization capability.

In step 426, the method includes validating the improvements. In some implementations, the method evaluates the performance of the retrained models against a held-out validation dataset to confirm that the changes result in genuine accuracy improvements. In some implementations, this validation process may include A/B testing of the new models against the previous models on a subset of users to measure real-world performance differences. The validation may consider not only aggregate accuracy metrics but also performance on previously identified problem areas to ensure that specific weaknesses have been addressed.

In step 428, the method includes deploying the updated models. After confirming improved performance, in some implementations, the method releases the new models to the production environment for use in generating future predictions. In some implementations, this deployment may follow a phased rollout strategy, gradually increasing the percentage of predictions generated by the new models while monitoring for any unexpected issues. In some implementations, the method may maintain the previous model version in parallel for a transition period to enable immediate rollback if necessary.

After step 428, the method ends. In some implementations, the updated models become the baseline for the next validation cycle, creating a continuous improvement loop that enhances prediction accuracy over time. In some implementations, the method may transition to a monitoring phase where the performance of the newly deployed models is observed in production.

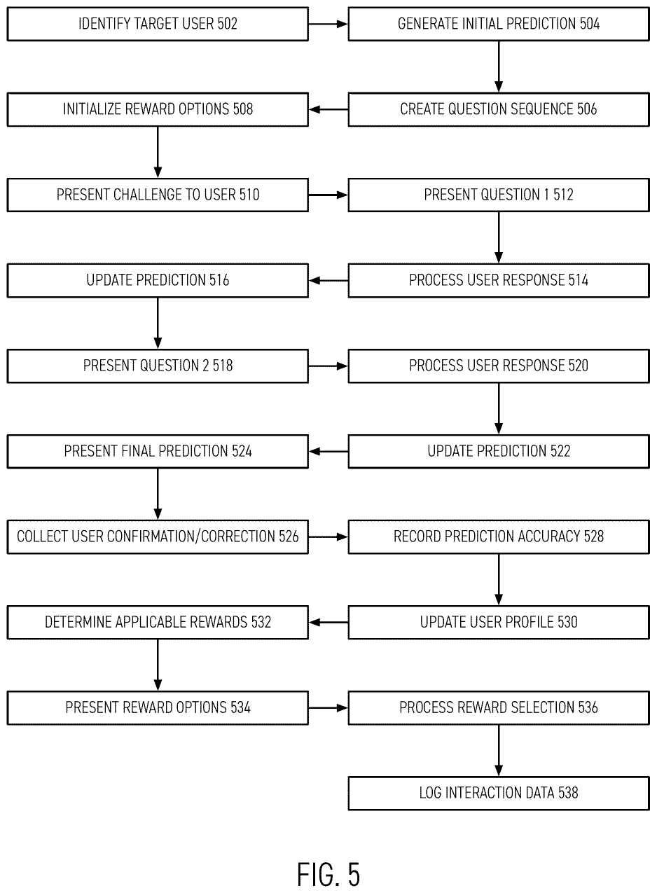

FIG. 5 is a flow diagram illustrating a method for executing an interactive challenge according to some of the disclosed embodiments.

In step 502, the method includes identifying a target user. In some implementations, the method selects a specific user within the household as the challenge recipient based on account information and engagement history. In some implementations, the method may use interaction patterns to determine which household member is the primary decision-maker for technology purchases, prioritizing that individual for challenge delivery. The selection algorithm may consider factors such as recent app usage, previous challenge engagement rates, and user permissions within the household account. In some implementations, the method may be triggered by various events, such as a scheduled engagement opportunity, a user accessing a mobile application, or the generation of a high-confidence prediction that warrants validation.

In step 504, the method includes generating an initial prediction. In some implementations, the method identifies the most likely next device purchase for the target user's household as the basis for the challenge. In some implementations, this initial prediction may be selected from previously generated predictions stored in the database, prioritizing those with high confidence scores or particular relevance to recent household activities. If multiple high-confidence predictions exist, the method may select one based on factors such as prediction novelty, potential user interest, or available partner rewards.

In step 506, the method includes creating a question sequence. In some implementations, the method designs a series of questions that will effectively validate the prediction while maintaining user engagement. In some implementations, this sequence generation may follow a decision tree approach where each question narrows the prediction space efficiently. The questions may be formulated to appear conversational rather than analytical, with personalization based on the user's profile and communication preferences. In some implementations, the method may limit the number of questions (typically 2-3) to maintain user interest and completion rates.

In step 508, the method includes initializing reward options. In some implementations, the method identifies potential rewards that could be offered to the user upon completion of the challenge, regardless of whether the prediction is confirmed or corrected. In some implementations, these rewards may include discounts on predicted devices or user-corrected alternatives, promotional offers from partners, or loyalty points within the ecosystem. In some implementations, the method may pre-select rewards that align with both the predicted devices and possible alternatives to ensure relevance regardless of the challenge outcome.

In step 510, the method includes presenting the challenge to the user. In some implementations, the method introduces the game concept through the user interface, explaining the process and potential rewards. In some implementations, this presentation may include animated elements, personalized messaging, and clear expectations about the time commitment required. The introduction may emphasize the mutual benefit of participation: enhanced recommendations for the user and improved prediction accuracy for the system.

In step 512, the method includes presenting the first question to the user. In some implementations, the method displays an initial question designed to confirm a key aspect of the prediction, such as the general category of interest. In some implementations, this first question may be deliberately broad to establish context before narrowing to specifics, such as “Are you considering purchasing any new smart home devices in the next three months?” The question presentation may include visual elements that enhance engagement, such as category icons or illustrations of representative devices.

In step 514, the method includes processing the user's response to the first question. In some implementations, the method captures and interprets the user's answer, including any additional context provided. In some implementations, this processing may include natural language processing for free-text responses or simple binary logic for yes/no answers. In some implementations, the method may also record metadata about the response, such as the time taken to answer and any hesitation patterns that might indicate uncertainty.

In step 516, the method includes updating the prediction based on the first response. In some implementations, the method refines its understanding of the user's purchase intentions, potentially adjusting the initial prediction. In some implementations, this update may involve recalculating probabilities across multiple potential acquisitions based on the new information. If the user's response contradicts the initial prediction, the method may activate an alternative prediction path that better aligns with the provided information.

In step 518, the method includes presenting the second question to the user. In some implementations, the method displays a follow-up question that builds on the information obtained from the first response, further refining the prediction validation. In some implementations, this second question may focus on more specific aspects such as brand preference, timing, or specific features of interest, such as “Would you prefer a device compatible with your existing Apple® products?” The question content and format may adapt based on the first response to create a logical conversation flow.

In step 520, the method includes processing the user's response to the second question. Similar to step 514, the method captures and interprets the second answer, including any additional context provided. In some implementations, the processing may compare consistency between the first and second responses to identify potential contradictions or clarify ambiguities.

In step 522, the method includes updating the prediction based on the second response. In some implementations, the method further refines its understanding of the user's purchase intentions based on the cumulative information from both responses. In some implementations, this updated prediction may include not only the most likely device but also a confidence score representing the method's certainty based on the interactive inputs compared to the original model-generated prediction.

In step 524, the method includes presenting the final prediction to the user. In some implementations, the method reveals what it believes to be the user's next likely purchase based on both the original prediction and the interactive responses. In some implementations, this presentation may include a visually engaging reveal animation that enhances the gamified nature of the challenge. In some implementations, the method may present the prediction as a deliberate “guess” rather than a technical calculation to maintain the game-like experience.

In step 526, the method includes collecting the user's confirmation or correction of the final prediction. In some implementations, the method prompts the user to validate whether the final prediction accurately reflects their intentions. In some implementations, this collection may include options for partial confirmation (e.g., correct category but wrong brand) or complete correction with the ability to specify the actual intended purchase. The interface may make confirmation/correction simple with clear options while still capturing nuanced feedback.

In step 528, the method includes recording the prediction accuracy. In some implementations, the method documents whether the final prediction was confirmed, partially confirmed, or corrected by the user, along with any specific details provided. In some implementations, this recording may include confidence ratings for the user's feedback based on response consistency and specificity. The accuracy record can be used as part of the training data for model improvement as described in FIG. 4.

In step 530, the method includes updating the user profile based on the interaction. In some implementations, the method enriches the household profile with the validated purchase intentions and preference information obtained through the challenge. In some implementations, this update may affect multiple aspects of the profile, including purchase timeframes, brand preferences, price sensitivity, and feature priorities. The method may assign expiration dates to intention data based on the user's indicated purchase timeline to prevent outdated intentions from influencing recommendations after a reasonable period.

In step 532, the method includes determining applicable rewards based on the challenge outcome. In some implementations, the method selects the most appropriate rewards to offer the user from the initialized options, considering the final confirmed or corrected prediction. In some implementations, this determination may prioritize rewards with high relevance to the validated purchase intention, regardless of whether it matched the original prediction. The method may also consider the user's reward history to provide variety and avoid repetition.

In step 534, the method includes presenting reward options to the user. In some implementations, the method displays the available rewards that the user can claim for completing the challenge. In some implementations, this presentation may include multiple options with clear value propositions, allowing the user to select the most personally relevant reward. The rewards presentation emphasizes that value is provided regardless of whether the method's prediction was accurate, reinforcing positive engagement with the validation process.

In step 536, the method includes processing the user's reward selection. In some implementations, the method captures the user's preferred reward choice and initiates the fulfillment process. In some implementations, this processing may include generating unique promotion codes, recording reward issuance in partner systems, or updating loyalty point balances within an ecosystem. The method may implement validation mechanisms to ensure rewards are properly tracked and cannot be claimed multiple times.

In step 538, the method includes logging comprehensive interaction data about the challenge session. In some implementations, the method records detailed information about the entire challenge flow, including questions, responses, timing, prediction updates, and reward selection. In some implementations, this logging may include session-level metrics such as completion time, engagement quality, and apparent user satisfaction. This interaction data supports both immediate validation objectives and longer-term user experience optimization.

After step 538, the method ends. In some implementations, the collected data becomes available for model validation and improvement processes as described in FIG. 4, while the user receives their selected reward, creating a mutually beneficial outcome.

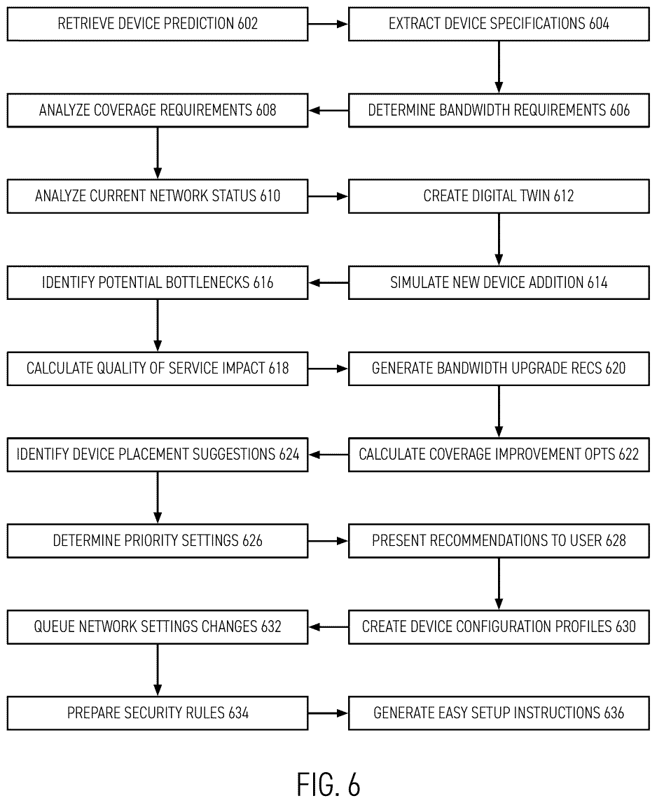

FIG. 6 is a flow diagram illustrating a method for optimizing network configurations based on predicted device acquisitions according to some of the disclosed embodiments.

In step 602, the method includes retrieving the device prediction. In some implementations, the method accesses the specific device prediction for which network optimization will be performed. In some implementations, this retrieval may include both the primary prediction (highest confidence) and alternative predictions (lower confidence but still probable) to enable comprehensive network planning. The method may prioritize predictions based on confidence score, predicted purchase timeline, and potential network impact to determine which ones warrant proactive optimization. The method may be triggered when the method generates a high-confidence device purchase prediction or when a user confirms an intended purchase through the interactive challenge described in FIG. 5.

In step 604, the method includes extracting device specifications. In some implementations, the method queries a device database to obtain detailed technical information about the predicted device. In some implementations, this database may contain thousands of device profiles including connectivity specifications, bandwidth requirements, supported protocols, and typical usage patterns. The database may be continuously updated as new devices enter the market, with specifications obtained from manufacturer documentation, industry databases, and observed behavior of similar devices on networks.

In step 606, the method includes determining bandwidth requirements. In some implementations, the method calculates the expected network bandwidth consumption of the predicted device based on its specifications and typical usage patterns. In some implementations, this calculation may consider multiple usage scenarios, from minimal to intensive use, to establish a range of potential bandwidth impacts. For example, a smart TV might be analyzed for both standard definition streaming (2-3 Mbps) and 4K HDR streaming (25+ Mbps) scenarios. The bandwidth assessment may also consider temporal patterns, such as peak usage times and potential concurrent usage with existing devices.

In step 608, the method includes analyzing coverage requirements. In some implementations, the method evaluates the predicted device's need for wireless signal strength, stability, and range based on its intended function and likely placement. In some implementations, this analysis may incorporate factors such as device mobility (stationary vs. mobile), sensitivity to latency (e.g., gaming devices, video conferencing), and tolerance for signal interruptions. The coverage assessment may also consider physical barriers and interference sources in the household based on previously mapped network conditions.

In step 610, the method includes analyzing current network status. In some implementations, the method gathers comprehensive data about the household's existing network performance, including bandwidth utilization, coverage mapping, device distribution, and quality of service metrics. In some implementations, this analysis may involve collecting real-time performance data from network nodes, reviewing historical performance trends, and identifying existing limitations or bottlenecks. The current network status serves as the baseline against which the impact of new devices will be assessed.

In step 612, the method includes creating a digital twin of the current network. In some implementations, the method generates a virtual model of the household network that represents its physical topology, logical configuration, and performance characteristics. In some implementations, this digital twin may incorporate detailed floor plan information (where available), wireless signal propagation modeling, and current device connection patterns. The model may be calibrated based on actual performance measurements to ensure accuracy in simulation. Advanced implementations may use computational fluid dynamics-inspired algorithms to model Wi-Fi signal propagation through the household's physical space.

In step 614, the method includes simulating the addition of the predicted device. In some implementations, the method introduces the virtual device into the digital twin model and simulates its operation on the network. In some implementations, this simulation may run multiple scenarios representing different usage patterns, placement locations, and times of day to comprehensively assess potential impacts. The simulation may model how the new device would communicate with existing infrastructure, compete for resources with other devices, and affect overall network dynamics.

In step 616, the method includes identifying potential bottlenecks. In some implementations, the method analyzes the simulation results to detect areas where the network might struggle to accommodate the new device. In some implementations, this analysis may identify issues such as bandwidth saturation during peak usage times, coverage gaps in likely device locations, interference from existing devices, or capacity limitations in specific network components. The bottleneck identification process may rank issues by severity and likelihood to prioritize addressing the most critical potential problems.

In step 618, the method includes calculating the quality-of-service impact. In some implementations, the method quantifies how the addition of the predicted device would affect the performance and reliability of both the new device and existing devices. In some implementations, this calculation may produce impact scores for metrics such as throughput, latency, jitter, and connection stability for each affected device. The quality of service assessment may also identify specific applications or services that might be most affected, such as video streaming, gaming, or work-from-home activities.

In step 620, the method includes generating bandwidth upgrade recommendations. Based on the identified bottlenecks and quality of service impacts, the method creates specific suggestions for improving network bandwidth if necessary. In some implementations, these recommendations may include upgrading the internet service plan, optimizing QoS settings to prioritize critical applications, or implementing bandwidth management policies. The recommendations may include specific bandwidth tiers appropriate for the household's needs, along with projected cost implications and benefit analyses.

In step 622, the method includes calculating coverage improvement options. In some implementations, the method determines what changes to the network infrastructure would address any identified coverage issues for the predicted device. In some implementations, these options may include repositioning existing access points, adding mesh nodes in specific locations, or upgrading to higher-power or more advanced equipment. The coverage recommendations may be generated through iterative simulations that test different network topologies to find optimal configurations with minimal hardware additions.

In step 624, the method includes identifying device placement suggestions. In some implementations, the method determines optimal locations for the predicted device that would maximize its network performance while minimizing negative impacts on other devices. In some implementations, these suggestions may include specific rooms, areas within rooms, or mounting heights that provide ideal signal reception. The placement recommendations may consider both network performance factors and practical aspects like proximity to power outlets or physical space constraints.

In step 626, the method includes determining priority settings. In some implementations, the method defines appropriate Quality of Service (QoS) and traffic prioritization rules for the predicted device based on its function and importance. In some implementations, these settings may position the new device appropriately within the household's device hierarchy, ensuring critical devices maintain necessary performance while accommodating the new addition. The priority determination may include time-based rules that adjust device priorities based on usage patterns throughout the day.

In step 628, the method includes presenting recommendations to the user. In some implementations, the method delivers the compiled network optimization suggestions through the user interface in an accessible and actionable format. In some implementations, this presentation may include visual elements such as coverage heat maps, bandwidth utilization graphs, and placement guidance overlaid on household floor plans where available. The recommendations may be prioritized by importance and urgency, with clear explanations of the benefits each change would provide. The presentation may also include timing recommendations, such as suggesting network upgrades before the predicted purchase occurs.

In step 630, the method includes creating device configuration profiles. In some implementations, the method generates network configuration settings specifically optimized for the predicted device. In some implementations, these profiles may include Wi-Fi connection settings, IP assignment parameters, DNS configurations, and security policies. The configuration profiles may be created in a format that can be automatically applied when the device is eventually connected to the network, minimizing manual setup requirements.

In step 632, the method includes queuing network settings changes. In some implementations, the method prepares automatic updates to network infrastructure settings that will be applied when appropriate to accommodate the predicted device. In some implementations, these queued changes may include VLAN configurations, port forwarding rules, DHCP reservations, and access control settings. In some implementations, the method may schedule these changes for immediate implementation, staged rollout, or activation upon device detection, depending on the nature of the settings and their potential impact on existing devices.

In step 634, the method includes preparing security rules. In some implementations, the method defines appropriate network security policies for the predicted device based on its type, manufacturer reputation, and known vulnerability profile. In some implementations, these security rules may include network isolation parameters, traffic monitoring settings, and access restrictions based on device classification. The security preparation may involve consulting continuously updated vulnerability databases and security best practices to protect both the new device and the overall network.

In step 636, the method includes generating easy setup instructions. In some implementations, the method creates user-friendly guidance for installing and configuring the predicted device when it is eventually purchased. In some implementations, these instructions may include step-by-step setup procedures, troubleshooting tips, and explanation of optimal settings specific to the household's network environment. The instructions may be formatted for delivery through multiple channels, including in-app guidance, printable documentation, or interactive tutorials, based on user preferences.

After step 636, the method ends. In some implementations, the generated recommendations, configurations, and instructions remain available for implementation when the user proceeds with the predicted purchase. In some implementations, the method may schedule periodic reassessments of the optimization plan if the purchase does not occur within the expected timeframe, ensuring recommendations remain current with evolving network conditions.

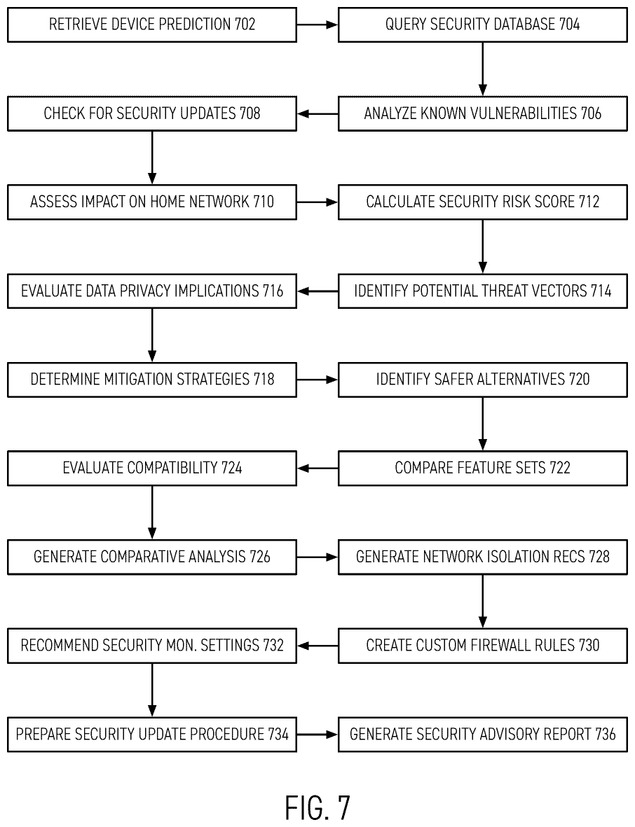

FIG. 7 is a flow diagram illustrating a method for assessing security implications of predicted device acquisitions according to some of the disclosed embodiments.

In step 702, the method includes retrieving the device prediction. In some implementations, the method accesses detailed information about the specific device predicted for purchase, including make, model, firmware version, and feature set. In some implementations, the device information may include multiple levels of specificity, from general device category (e.g., security camera) to specific manufacturer and model (e.g., Brand X Model Y), depending on the confidence level of the prediction. This detailed device information forms the foundation for the subsequent security analysis. The method may be triggered automatically when the method generates a high-confidence device prediction or when a user confirms an intended purchase

### Through the Interactive Challenge.

In step 704, the method includes querying a security database. In some implementations, the method accesses a comprehensive database of device security information, including known vulnerabilities, manufacturer security practices, and historical security incidents. In some implementations, this database may be maintained through a combination of automated vulnerability feeds from sources such as the National Vulnerability Database (NVD), manufacturer security bulletins, and proprietary security research. The database may be continuously updated as new vulnerabilities are discovered, providing current security intelligence for even recently released devices.

In step 706, the method includes analyzing known vulnerabilities. In some implementations, the method evaluates specific security weaknesses associated with the predicted device, including their severity, exploitability, and potential impact. In some implementations, this analysis may categorize vulnerabilities using standardized frameworks such as the Common Vulnerability Scoring System (CVSS), which provides numerical scores (typically 0-10) representing the severity of security issues. The vulnerability analysis may consider not only current firmware versions but also the manufacturer's history of providing security updates to assess the long-term security posture of the device.

In step 708, the method includes checking for security updates. In some implementations, the method determines whether identified vulnerabilities have been addressed through manufacturer patches or firmware updates. In some implementations, this check may involve comparing the latest available firmware version against the versions affected by known vulnerabilities. In some implementations, the method may also assess the manufacturer's responsiveness to security issues by analyzing the average time between vulnerability disclosure and patch release, providing insights into the expected security maintenance of the device over its lifetime.

In step 710, the method includes assessing the impact on the home network. In some implementations, the method evaluates how the predicted device's security profile might affect the overall network security posture. In some implementations, this assessment may consider factors such as the device's required network permissions, protocols used, data access needs, and integration with other systems or cloud services. The impact assessment may analyze how the device would interact with existing network segments, potential access to sensitive data, and whether it introduces new attack surfaces to the household network.

In step 712, the method includes calculating a security risk score. Based on the vulnerability analysis and network impact assessment, the method generates a quantitative measure of the security risk posed by the predicted device. In some implementations, this score may incorporate multiple factors weighted according to their security significance, including vulnerability severity, patch availability, required network permissions, data sensitivity, and manufacturer security reputation. The security risk score provides a simplified representation of complex security considerations that can be easily communicated to users.

In step 714, the method includes identifying potential threat vectors. In some implementations, the method determines specific ways in which the predicted device could be compromised or exploited. In some implementations, this identification may involve mapping known attack patterns to the device's architecture and connectivity model. For example, the method might identify risks such as default credential exploitation, unencrypted data transmission, remote code execution vulnerabilities, or insecure cloud connectivity. This threat vector analysis provides concrete scenarios that help contextualize abstract security concepts for users.

In step 716, the method includes evaluating data privacy implications. In some implementations, the method assesses what types of personal data the predicted device may collect, how that data is processed and stored, and potential privacy concerns. In some implementations, this evaluation may analyze privacy policies, data sharing agreements, and known data handling practices of the device manufacturer. The privacy assessment may consider regional data protection regulations such as GDPR or CCPA and evaluate the device's compliance with applicable requirements. In some implementations, the method may also evaluate whether the device requires excessive permissions or collects data beyond what is necessary for its core functionality.

In step 718, the method includes determining mitigation strategies. Based on the identified risks and vulnerabilities, the method develops specific approaches to reduce security concerns while still allowing use of the predicted device. In some implementations, these strategies may include network isolation, custom security rules, enhanced monitoring, or specific configuration recommendations that disable high-risk features. The mitigation approaches balance security considerations with functionality needs, focusing on practical solutions that don't significantly degrade the user experience.

In step 720, the method includes identifying safer alternatives. If the predicted device presents substantial security concerns, the method identifies alternative products with similar functionality but better security profiles. In some implementations, this identification may leverage the device database to find comparable devices that have fewer known vulnerabilities, better update histories, stronger encryption implementations, or more privacy-respecting data practices. The alternative identification process may consider both the primary functionality of the predicted device and any secondary features important to the user.

In step 722, the method includes comparing feature sets. In some implementations, the method evaluates how the identified alternatives compare to the predicted device in terms of functionality, capabilities, and user experience. In some implementations, this comparison may generate feature matrices that highlight the strengths and weaknesses of each option across multiple dimensions. The feature comparison ensures that security recommendations don't lead users to significantly less capable devices, focusing instead on alternatives that maintain similar functionality with improved security characteristics.

In step 724, the method includes evaluating compatibility. In some implementations, the method assesses how well each alternative would integrate with the household's existing technology ecosystem. In some implementations, this evaluation may consider factors such as protocol support, integration with current smart home platforms, compatibility with existing devices, and alignment with the household's observed ecosystem preferences. The compatibility assessment ensures that security-motivated alternatives remain practical within the user's established technology environment.

In step 726, the method includes generating a comparative analysis. In some implementations, the method creates a comprehensive comparison between the predicted device and safer alternatives, highlighting security benefits alongside any functional tradeoffs. In some implementations, this analysis may include visualizations such as radar charts or comparison tables that make complex tradeoff decisions more accessible to users. The comparative analysis provides balanced information that empowers users to make security-conscious purchasing decisions without feeling forced toward specific products.

In step 728, the method includes generating network isolation recommendations. In some implementations, the method creates specific guidance for segregating the predicted device from sensitive network resources if the user proceeds with the purchase. In some implementations, these recommendations may include VLAN configurations, IoT-specific network segments, or access control lists that limit the device's communication to only necessary endpoints. The isolation recommendations may be automatically implementable through the network management system, reducing the technical complexity for users.

In step 730, the method includes creating custom firewall rules. In some implementations, the method develops specific network traffic policies to mitigate the device's identified security risks. In some implementations, these rules may include blocking unnecessary outbound connections, limiting communication to authorized cloud endpoints, or implementing rate limiting to prevent compromise of the device for malicious purposes such as DDoS attacks. The firewall rules may adapt based on observed behavior patterns, becoming more precise as the method learns legitimate usage patterns after device installation.

In step 732, the method includes recommending security monitoring settings. In some implementations, the method configures enhanced vigilance for the predicted device's network activities to detect potential security incidents. In some implementations, these monitoring recommendations may include behavioral baselines, anomaly detection thresholds, and specific warning signs that might indicate compromise. The monitoring settings may integrate with the overall network security system to provide comprehensive protection without requiring separate management interfaces.

In step 734, the method includes preparing a security update procedure. In some implementations, the method creates a specific plan for maintaining the predicted device's security posture over time through firmware updates and configuration changes. In some implementations, this procedure may include automated update checking, notification systems for critical security patches, and backup procedures to protect device configurations during updates. The update procedure ensures that the initial security assessment remains relevant throughout the device's lifecycle.

In step 736, the method includes generating a security advisory report. In some implementations, the method compiles all security analyses, recommendations, and alternatives into a comprehensive document presented to the user. In some implementations, this report may include an executive summary with the security risk score, key findings, and most important recommendations, followed by detailed sections addressing specific security aspects. The advisory report presents technical security information in an accessible format that helps users make informed decisions without requiring specialized security knowledge.

After step 736, the method ends. The generated security recommendations and alternatives remain available to guide the user's purchasing decision and network configuration when they proceed with acquiring new devices.

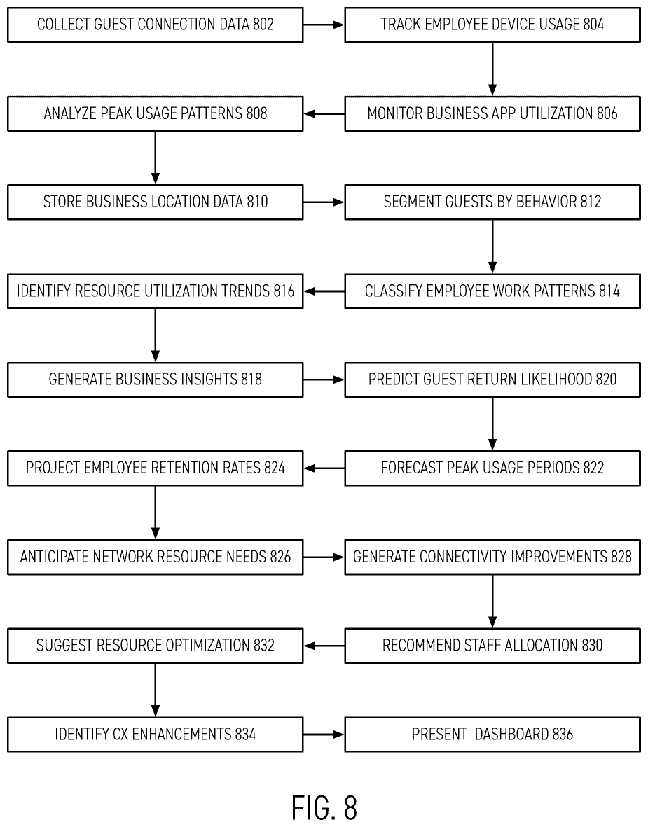

FIG. 8 is a flow diagram illustrating a method for applying prediction and analysis capabilities to business environments according to some of the disclosed embodiments.

In step 802, the method includes collecting guest connection data. In some implementations, the method gathers information about visitors connecting to the business network, including connection frequency, duration, and device types. In some implementations, this collection may capture MAC addresses (appropriately hashed for privacy), device fingerprints, connection timestamps, and bandwidth utilization patterns. In some implementations, the method may differentiate between first-time and returning visitors by recognizing previously seen devices. For privacy compliance, the data collection may implement configurable retention policies and anonymization techniques that align with regional regulations while preserving analytical utility. The process may operate continuously or may be triggered at regular intervals to provide updated business insights and forecasts.

In step 804, the method includes tracking employee device usage. In some implementations, the method monitors how staff members utilize the network infrastructure, identifying work patterns and resource needs. In some implementations, this tracking may associate devices with employee roles (rather than specific individuals) to balance analytical insights with privacy considerations. The employee device tracking may capture work hours, application usage patterns, mobility within the location, and connectivity requirements. This data provides visibility into operational workflows without requiring intrusive monitoring of individual employees.

In step 806, the method includes monitoring business application utilization. In some implementations, the method analyzes usage patterns of business-critical applications and services accessed through the network. In some implementations, this monitoring may categorize application traffic by type (e.g., point-of-sale, inventory management, customer relationship management) and track usage volumes, peak periods, and performance metrics. The application utilization data helps identify which business systems are most critical during different operational periods and potential bottlenecks affecting productivity.

In step 808, the method includes analyzing peak usage patterns. In some implementations, the method identifies temporal patterns in network utilization, including daily, weekly, and seasonal variations in demand. In some implementations, this analysis may employ time-series decomposition techniques to separate regular patterns from anomalies and trending changes. In some implementations, the method may correlate network usage with business factors such as operating hours, promotional events, or external factors like weather conditions or local events. This temporal analysis provides context for capacity planning and operational optimization.

In step 810, the method includes storing business location data. In some implementations, the method saves all collected information to a persistent database for longitudinal analysis and pattern recognition. In some implementations, this storage may implement business-appropriate data governance practices, including role-based access controls, encryption for sensitive data, and configurable retention policies. The database structure may optimize for both analytical queries (supporting business intelligence) and real-time access (supporting operational decisions), potentially using a hybrid storage architecture.

In step 812, the method includes segmenting guests by behavior. In some implementations, the method categorizes visitors based on their interaction patterns with the business network. In some implementations, this segmentation may identify groups such as one-time visitors, regular customers, power users, or specific demographic cohorts based on observable device and usage characteristics. The segmentation algorithms may employ clustering techniques such as k-means, hierarchical clustering, or more sophisticated approaches like DBSCAN for identifying groups with similar behavioral patterns. These guest segments enable targeted business strategies and personalized experiences.

In step 814, the method includes classifying employee work patterns. In some implementations, the method identifies different operational modes and productivity profiles among the workforce. In some implementations, this classification may recognize patterns such as front-of-house vs. back-office workers, desk-based vs. mobile staff, or technology-intensive vs. minimal technology roles. The classification may adapt over time as roles evolve or as the business introduces new operational processes. These employee classifications inform staffing models, technology provisioning, and workspace design decisions.

In step 816, the method includes identifying resource utilization trends. In some implementations, the method detects evolving patterns in how network and technology resources are consumed over time. In some implementations, this trend identification may employ statistical techniques such as moving averages, linear regression, or more complex time-series analysis methods to distinguish short-term fluctuations from meaningful directional changes. In some implementations, the method may flag both positive trends (e.g., increasing efficiency) and concerning trends (e.g., growing congestion) that warrant attention. These resource utilization trends support proactive management of technology infrastructure.

In step 818, the method includes generating business insights. In some implementations, the method synthesizes the analyzed data into actionable observations about business operations, customer behavior, and efficiency opportunities. In some implementations, these insights may include key performance indicators, comparative benchmarks against similar business locations, and identification of operational anomalies or opportunities. The insight generation process may employ both rule-based approaches for known patterns and machine learning techniques to discover unexpected relationships in the data. These business insights translate raw data into business-relevant findings.

In step 820, the method includes predicting guest return likelihood. In some implementations, the method forecasts the probability that visitors will return to the business location based on their observed behaviors. In some implementations, this prediction may use survival analysis or similar techniques to model the time-to-return distribution for different guest segments. The return likelihood models may incorporate factors such as visit frequency, duration, resource utilization, and seasonal patterns. These predictions help businesses understand customer loyalty and the effectiveness of retention efforts.

In step 822, the method includes forecasting peak usage periods. In some implementations, the method predicts future periods of high demand for network resources based on historical patterns and upcoming events. In some implementations, this forecasting may employ time-series prediction methods such as ARIMA, Prophet, or machine learning approaches that can capture complex seasonal patterns and trend components. The forecasts may include confidence intervals to represent prediction uncertainty, particularly for longer time horizons. These peak usage forecasts support capacity planning and staffing decisions.

In step 824, the method includes projecting employee retention rates. In some implementations, the method estimates the likelihood of staff turnover based on observed changes in work patterns and network usage behaviors. In some implementations, this projection may identify potential attrition risk by detecting behavioral changes often associated with decreased engagement or job searching, such as altered work hours, reduced application usage, or changes in connection patterns. The retention projections may be aggregated at the role or department level rather than individually to maintain privacy while still providing actionable workforce intelligence.

In step 826, the method includes anticipating network resource needs. In some implementations, the method predicts future infrastructure requirements based on observed trends and forecasted changes in business operations. In some implementations, this anticipation may generate capacity forecasts for bandwidth, connection density, coverage requirements, and application hosting needs. The resource forecasting may consider both organic growth patterns and step-changes from planned business initiatives or technological shifts. These anticipated needs enable proactive infrastructure planning rather than reactive responses to capacity issues.

In step 828, the method includes generating connectivity improvement recommendations. Based on the analysis and predictions, the method creates specific suggestions for enhancing the business network infrastructure. In some implementations, these recommendations may include access point placement optimization, bandwidth upgrades, QoS policy adjustments, or technology refresh priorities. The recommendation engine may simulate the expected impact of each suggested change to quantify potential benefits and support return-on-investment calculations. These connectivity recommendations translate technical insights into practical improvement plans.

In step 830, the method includes recommending staff allocation. In some implementations, the method suggests workforce distribution adjustments based on predicted customer patterns and operational needs. In some implementations, these recommendations may include optimal staffing levels for different business areas, shift timing adjustments to align with customer demand, or role distribution based on anticipated service needs. The staffing recommendations may integrate with existing workforce management systems through APIs to streamline implementation. These allocation recommendations help businesses match resources to customer expectations.

In step 832, the method includes suggesting resource optimization. In some implementations, the method identifies opportunities to improve efficiency in technology resource utilization. In some implementations, these suggestions may include consolidating underutilized services, redistributing computing workloads to off-peak hours, or implementing caching strategies for bandwidth-intensive applications. The optimization engine may prioritize suggestions based on potential impact and implementation complexity to focus attention on high-value opportunities. These optimization suggestions help businesses reduce costs while maintaining service quality.

In step 834, the method includes identifying customer experience enhancements. In some implementations, the method recommends improvements to the guest experience based on observed behaviors and pain points. In some implementations, these recommendations may include simplified login processes for returning customers, personalized connection experiences based on visit history, or targeted bandwidth allocation for business-critical guest applications. The experience enhancement suggestions may be designed for seamless implementation through the existing network infrastructure. These experience recommendations help businesses differentiate their service through superior connectivity.

In step 836, the method includes presenting a business intelligence dashboard. In some implementations, the method delivers all insights, predictions, and recommendations through an interactive visualization interface designed for business stakeholders. In some implementations, this dashboard may include multiple views tailored to different roles, from executive summaries to detailed operational analytics. The dashboard may implement progressive disclosure principles, allowing users to explore high-level findings and then drill down into supporting details as needed. Real-time data feeds may update key metrics continuously while longer-term analyses refresh at appropriate intervals. The dashboard translates complex technical data into business-relevant visualizations and actionable information.

After step 836, the method ends. The generated insights and recommendations remain available through the business intelligence dashboard, and the method continues to collect new data that will inform the next analysis cycle. This continuous improvement loop enables ongoing refinement of business operations based on empirical evidence rather than intuition alone.

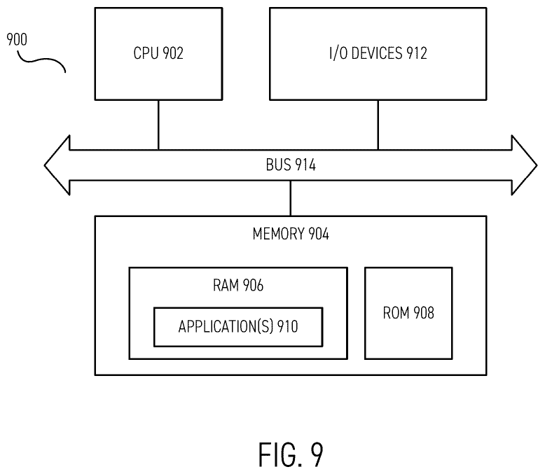

FIG. 9 is a block diagram of a computing device according to some embodiments of the disclosure.

As illustrated, the device 900 includes a processor or central processing unit (CPU) such as CPU 902 in communication with a memory 904 via a bus 914. The device also includes one or more input/output (I/O) or peripheral devices 912. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 902 may comprise a general-purpose processor. The CPU 902 may comprise a single-core or multiple-core processor. The CPU 902 may comprise a system-on-a-chip (SoC) processor or a similar embedded system or processor. In some embodiments, a graphics processing unit (GPU) may be used in place of, or in combination with, a CPU 902. Memory 904 may comprise a memory system including a dynamic random-access memory (DRAM), static random-access memory (SRAM), Flash (e.g., NAND Flash), or combinations thereof. In one embodiment, the bus 914 may comprise a Peripheral Component Interconnect Express (PCIe) bus. In some embodiments, the bus 914 may comprise multiple busses instead of a single bus.

Memory 904 illustrates an example of a non-transitory computer storage media for the storage of information such as computer-readable instructions, data structures, program modules, or other data. Memory 904 can store a basic input/output system (BIOS) in read-only memory (ROM), such as ROM 908 for controlling the low-level operation of the device. The memory can also store an operating system in random-access memory (RAM) for controlling the operation of the device.

Applications 910 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 906 by a processor, such as CPU 902. The CPU 902 may then read the software or data from RAM 906, process them, and store them in RAM 906 again.

The device may optionally communicate with a base station (not shown) or directly with another computing device. One or more network interfaces in peripheral devices 912 are sometimes referred to as a transceiver, transceiving device, or network interface card (NIC).

An audio interface in peripheral devices 912 produces and receives audio signals such as the sound of a human voice. For example, an audio interface may be coupled to a speaker and microphone (not shown) to enable telecommunication with others or generate an audio acknowledgment for some action. Displays in peripheral devices 912 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 912 may comprise any input device arranged to receive input from a user. An illuminator in peripheral devices 912 may provide a status indication or provide light. The device can also comprise an input/output interface in peripheral devices 912 for communication with external devices, using communication technologies, such as USB, infrared, Bluetooth®, or the like. A haptic interface in peripheral devices 912 provides tactile feedback to a user of the client device.

A GPS receiver in peripheral devices 912 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 8, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
collecting, by a processor, network data from a household network, the network data comprising one or more of device inventory data, application usage data, and network usage patterns;
generating, by the processor, a feature vector based on the network data;
inputting, by the processor, the feature vector into a machine learning model trained to predict future device additions to the household network;
receiving, by the processor, a prediction from the machine learning model, the prediction identifying a device type predicted to be added to the household network;
storing, by the processor, the prediction in a database;
monitoring, by the processor, the household network to detect actual device additions;
comparing, by the processor, the actual device additions with the prediction to determine a prediction accuracy value; and
updating, by the processor, the machine learning model based on the prediction accuracy value.

2. The method of claim 1, wherein collecting network data from the household network comprises:
identifying connected devices on the household network;
determining a device type, brand, and model for each identified connected device;
monitoring application access patterns through the household network; and
measuring bandwidth consumption and peak usage times.

3. The method of claim 1, further comprising:
generating, by the processor, network optimization parameters based on the prediction, the network optimization parameters comprising bandwidth allocation settings, coverage requirements, and device placement recommendations;
creating, by the processor, a digital twin of the household network;
simulating, by the processor, addition of the device type to the digital twin; and
generating, by the processor, modified network settings based on simulation results.

4. The method of claim 1, further comprising:
generating, by the processor, a security risk assessment for the device type;
querying, by the processor, a vulnerability database to identify security vulnerabilities associated with the device type;
calculating, by the processor, a security risk score based on the security vulnerabilities; and
generating, by the processor, security mitigation recommendations based on the security risk score.

5. The method of claim 1, wherein the machine learning model comprises:
a first prediction model trained to predict a device category; and
a second prediction model trained to predict a specific device type within the device category, wherein the prediction includes both the device category and the specific device type.

6. The method of claim 1, further comprising:
generating, by the processor, an interactive challenge for a user based on the prediction;
presenting, by the processor, a sequence of questions to the user through a user interface;
receiving, by the processor, user responses to the sequence of questions;
comparing, by the processor, the user responses with the prediction to determine an interactive validation score; and
updating, by the processor, the machine learning model based on the interactive validation score.

7. The method of claim 1, wherein updating the machine learning model based on the prediction accuracy value comprises:
identifying, by the processor, prediction error patterns;
updating, by the processor, a training dataset to include the actual device additions;
adjusting, by the processor, feature extraction parameters based on the prediction error patterns; and
retraining, by the processor, the machine learning model using the training dataset and adjusted feature extraction parameters.

8. A non-transitory computer-readable storage medium for tangibly storing computer program instructions capable of being executed by a processor, the computer program instructions defining steps of:
collecting, by a processor, network data from a household network, the network data comprising one or more of device inventory data, application usage data, and network usage patterns;
generating, by the processor, a feature vector based on the network data;
inputting, by the processor, the feature vector into a machine learning model trained to predict future device additions to the household network;
receiving, by the processor, a prediction from the machine learning model, the prediction identifying a device type predicted to be added to the household network;
storing, by the processor, the prediction in a database;
monitoring, by the processor, the household network to detect actual device additions;
comparing, by the processor, the actual device additions with the prediction to determine a prediction accuracy value; and
updating, by the processor, the machine learning model based on the prediction accuracy value.

9. The non-transitory computer-readable storage medium of claim 8, wherein collecting network data from the household network comprises:
identifying connected devices on the household network;
determining a device type, brand, and model for each identified connected device;
monitoring application access patterns through the household network; and
measuring bandwidth consumption and peak usage times.

10. The non-transitory computer-readable storage medium of claim 8, the steps further comprising:
generating, by the processor, network optimization parameters based on the prediction, the network optimization parameters comprising bandwidth allocation settings, coverage requirements, and device placement recommendations;
creating, by the processor, a digital twin of the household network;
simulating, by the processor, addition of the device type to the digital twin; and
generating, by the processor, modified network settings based on simulation results.

11. The non-transitory computer-readable storage medium of claim 8, the steps further comprising:
generating, by the processor, a security risk assessment for the device type;
querying, by the processor, a vulnerability database to identify security vulnerabilities associated with the device type;
calculating, by the processor, a security risk score based on the security vulnerabilities; and
generating, by the processor, security mitigation recommendations based on the security risk score.

12. The non-transitory computer-readable storage medium of claim 8, wherein the machine learning model comprises:
a first prediction model trained to predict a device category; and
a second prediction model trained to predict a specific device type within the device category, wherein the prediction includes both the device category and the specific device type.

13. The non-transitory computer-readable storage medium of claim 8, the steps further comprising:
generating, by the processor, an interactive challenge for a user based on the prediction;
presenting, by the processor, a sequence of questions to the user through a user interface;
receiving, by the processor, user responses to the sequence of questions;
comparing, by the processor, the user responses with the prediction to determine an interactive validation score; and
updating, by the processor, the machine learning model based on the interactive validation score.

14. The non-transitory computer-readable storage medium of claim 8, wherein updating the machine learning model based on the prediction accuracy value comprises:
identifying, by the processor, prediction error patterns;
updating, by the processor, a training dataset to include the actual device additions;
adjusting, by the processor, feature extraction parameters based on the prediction error patterns; and
retraining, by the processor, the machine learning model using the training dataset and adjusted feature extraction parameters.

15. A device comprising:
a processor; and
a storage medium for tangibly storing thereon program logic for execution by the processor, the program logic comprising steps for:
collecting, by the processor, network data from a household network, the network data comprising one or more of device inventory data, application usage data, and network usage patterns;
generating, by the processor, a feature vector based on the network data;
inputting, by the processor, the feature vector into a machine learning model trained to predict future device additions to the household network;
receiving, by the processor, a prediction from the machine learning model, the prediction identifying a device type predicted to be added to the household network;
storing, by the processor, the prediction in a database;
monitoring, by the processor, the household network to detect actual device additions;
comparing, by the processor, the actual device additions with the prediction to determine a prediction accuracy value; and
updating, by the processor, the machine learning model based on the prediction accuracy value.

16. The device of claim 15, wherein collecting network data from the household network comprises:
identifying connected devices on the household network;
determining a device type, brand, and model for each identified connected device;
monitoring application access patterns through the household network; and
measuring bandwidth consumption and peak usage times.

17. The device of claim 15, the steps further comprising:
generating, by the processor, network optimization parameters based on the prediction, the network optimization parameters comprising bandwidth allocation settings, coverage requirements, and device placement recommendations;
creating, by the processor, a digital twin of the household network;
simulating, by the processor, addition of the device type to the digital twin; and
generating, by the processor, modified network settings based on simulation results.

18. The device of claim 15, the steps further comprising:
generating, by the processor, a security risk assessment for the device type;
querying, by the processor, a vulnerability database to identify security vulnerabilities associated with the device type;
calculating, by the processor, a security risk score based on the security vulnerabilities; and
generating, by the processor, security mitigation recommendations based on the security risk score.

19. The device of claim 15, the steps further comprising:
generating, by the processor, an interactive challenge for a user based on the prediction;
presenting, by the processor, a sequence of questions to the user through a user interface;
receiving, by the processor, user responses to the sequence of questions;
comparing, by the processor, the user responses with the prediction to determine an interactive validation score; and
updating, by the processor, the machine learning model based on the interactive validation score.

20. The device of claim 15, wherein updating the machine learning model based on the prediction accuracy value comprises:
identifying, by the processor, prediction error patterns;
updating, by the processor, a training dataset to include the actual device additions;
adjusting, by the processor, feature extraction parameters based on the prediction error patterns; and
retraining, by the processor, the machine learning model using the training dataset and adjusted feature extraction parameters.
